(19) United States
(12) Patent Application Publication
(10) Pub. No.: US 2006/0100845 A1
(43) Pub. Date: May 11, 2006

(54) Multiple stream real time data simulation adapted for a KStore data structure

(76) Inventors: Jane Campbell Mazzagatti, Blue Bell, PA (US); Tony T. Phan, Abington, PA (US)

Correspondence Address: Unisys Corporation;Attn: Michael B. Atlass, Unisys Way, MS/E8-114, Blue Bell, PA, 19424-0001, US

(21) Appl. No.: 11/106,253

(22) Filed: Apr. 14, 2005

Related U.S. Application Data
(60) Provisional application No. 60/625,922, filed on Nov. 8, 2004.

(51) Int. Cl. G06F 9/45

(52) U.S. Cl. 703/22

(57) ABSTRACT

A method for generating data for a KStore includes collecting modeled process defining parameters to provide a defined modeled process and instantiating a first simulator. A data stream is created by the simulator in accordance with the defined modeled process and a data stream is transmitted to a data storage device. Executing a single thread and executing a plurality of threads by the first simulator are set forth. A single set of modeled process defining parameters is collected. A data stream of the single modeled process is provided in accordance with the single set of modeled process defining parameters. A second simulator can be instantiated and a single thread or a plurality of threads can be executed on the second simulator. A plurality of sets of modeled process defining parameters is collected and a plurality data streams of the modeled processes are provided in accordance with the plurality of sets of modeled process defining parameters.

### BACKGROUND OF THE INVENTION

1. Field of Invention

This invention relates to computing and in particular to the field of storing and accessing data in datastores.

2. Description of Related Art

Simulators for providing streams of data to populate data structures for testing and demonstration of the data structures are well known in the art. Most commonly the known simulators use a complex matrix to generate a single stream of data modeling the descriptive variable probabilities of some process.

In this patent we refer to such processes as modeled processes or model processes. They can be any modeled process, for example, the growth of trees in a forest, sales transactions in a retail store, shipping activities of a delivery company, growth of a human being, disease progress in a cancer patient, refining of crude oil, availability of water supply to a city over time, and wafer fabrication in a semiconductor plant, or anything that can be modeled. We identify modeled processes separately from the normal use of the word process, because we need to identify what the simulator is producing as data for a modeled process, while the steps that accomplish that generation of data is itself a process.

A thread—sometimes called an execution context or a lightweight process—is a single sequential flow of control within a program. Each thread is generally a sequential flow of control within the same program. For background on this, see http://www.serpentine.com/˜bos/os-faq/FAQ-1.html#Threads for a discussion on Threads and their history. Threads are defined as light weight processes. They can be thought of as the basic unit of CPU scheduling and a sequential execution stream within a process. A common definition of processes is that they have five fundamental parts; code, data, stack, file I/O and signal tables. This creates a significant amount of overhead when switching. Threads reduce overhead by sharing fundamental parts. By sharing, switching execution from one thread to another can happen much more frequently and efficiently.

Threads are an integral part of any operating system. However, three of the industry's leaders all have differing concepts about how to implement threads. In this application we use the term “Thread” or “thread” mainly to indicate a software process that handles a Simulator function from the initiation of such a Simulator function to its termination.

With the development of KStore technology a need for data simulators to test and demonstrate the KStore data structure and functionality arose. However, the available database technology did not support the data streaming requirements of the KStore. For example, the prior art data simulators did not support the multiple real time data stream inputs which were required to test and demonstrate the capabilities of the KStore data structure. Furthermore, it follows that the prior art data simulators did not support the input streams in multiple formats required for testing and demonstrating the capabilities of the KStore.

All references cited herein are incorporated herein by reference in their entireties.

### BRIEF SUMMARY OF THE INVENTION

A method for generating data for a KStore includes collecting modeled process defining parameters to provide at least one defined modeled process and instantiating a first simulator. A data stream is created by the at least one simulator in accordance with the defined modeled process and at least one data stream is transmitted to a data storage device. Executing a single thread by the first simulator and executing a plurality of threads by the first simulator are set forth. A single set of modeled process defining parameters is collected and a single modeled process is provided in accordance with the single set of modeled process defining parameters.

A second simulator can be instantiated and a single thread can be executed on the second simulator. Additionally, a plurality of threads can be executed on the second simulator. A plurality of sets of modeled process defining parameters is collected and a plurality of modeled processes are provided in accordance with the plurality of sets of modeled process defining parameters. A plurality of data streams is transmitted according to the plurality of threads and the plurality of data streams is transmitted to a single KStore. The data streams of the plurality of data streams can be transmitted in real time. Furthermore, the data streams of the plurality of data streams can be transmitted simultaneously.

A plurality of sets of modeled process defining parameters is collected and a plurality of modeled processes is provided in accordance with the plurality of sets of modeled process defining parameters. A plurality of data streams is transmitted according to the plurality of threads. The plurality of data streams can be transmitted to a single KStore. Furthermore, the plurality of data streams can be transmitted in real time. Additionally, the plurality of data streams can be transmitted simultaneously. Additionally, the plurality of data streams can be transmitted to a plurality of KStores or to a temporary data storage device. A plurality of data streams can be transmitted according to the first simulator. The method of the invention further includes collecting a plurality of sets of modeled process defining parameters and providing a plurality of modeled processes in accordance with the plurality of sets of modeled process defining parameters.

The simulator of the present invention meets the requirements for building, testing and demonstrating the KStore data structure by providing real time data stream inputs, multiple data streams, multiple data formats and random generation of sets of data. It can provide one instance of every possible combination of data record values for the KStore data structure and it can assign default probabilities to variables if a user does not provide them

Thus, the simulator of the present invention is adapted to simulate simple, complex and contexted modeled processes by providing multiple data streams in multiple data formats in real time and transmitting them to a KStore or other repository. In one embodiment the simulator can randomly generate instances of data sequences based upon user-supplied configuration data, data from backing stores or other sources, including simulator generated sources and non-simulator generated real world data. It can continue to provide randomly generated sets of data until it provides one instance of every possible combination or continue indefinitely generating sets of data, including duplicate data. Additionally, the simulator of the present invention can assign default probability values to variables or accept probability values from a user or other source.

A graphical user interface (GUI), an application, or a background job allows for the input of defining parameters into the system of the present invention. The input can include the number of fields per record and the number of variables per field. If no specific values are specified for a field of variables default values are created. The newly created records may be sent directly to the learn engine of the KStore or to some other file where they can be accessed by the learn engine at a later time (push or pull). Additionally, the simulator can be directed to generate one or multiple threads to test processor usage during a KStore build.

### BRIEF DESCRIPTION OF SEVERAL VIEWS OF THE DRAWINGS

The invention will be described in conjunction with the following drawings in which like reference numerals designate like elements and wherein:

FIG. 1 shows a block diagram representation of an embodiment of the KStore dataset simulation system of the present invention.

FIG. 2 shows a graphical representation of an interlocking trees datastore for which data records having a single data source context can be simulated in accordance with the KStore dataset simulation system of FIG. 1.

FIG. 3 shows a graphical representation of an interlocking trees datastore for which data records having multiple data source contexts can be simulated in accordance with the KStore dataset simulation system of FIG. 1.

FIG. 4 shows a graphical representation of an alternate embodiment of the single data source context interlocking trees datastore of FIG. 3 including sign nodes indicating the multiple data source contexts.

FIG. 5 shows a graphical representation of an additional interlocking trees datastore for which data records having a single data source context can be simulated in accordance with the KStore dataset simulation system of FIG. 1.

FIG. 6 shows a screen shot of a graphic user interface suitable for use with the KStore dataset simulation system of the present invention to input parameters into the KStore dataset simulation system to define the number of processes represented in the KStore.

FIG. 7 shows a flow chart representation of an process for creating data records according to the KStore dataset simulation system of FIG. 1.

FIG. 8 shows a block diagram representation of possible configurations of a data simulator according to the KStore dataset simulation system of FIG. 1.

FIGS. 9A, B show screen shots of a graphic user interface suitable for use with the KStore dataset simulation system of the present invention to instantiate a simulator or a scenario.

### DETAILED DESCRIPTION OF THE INVENTION

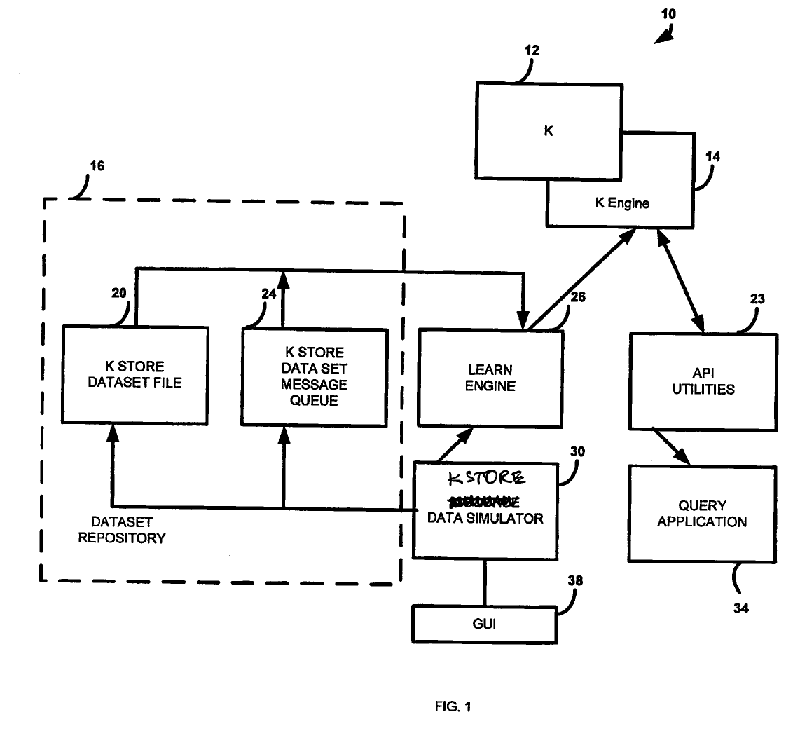

Referring now to FIG. 1, there is shown a block diagram representation of the KStore dataset simulation system 10 of the present invention. The KStore dataset simulation system 10 can be used to create a dataset defined by a user for transmission to the K Engine 14 or other storage device for storage or for operations such as building and testing the KStore 12. Responses to queries received by the K Engine 14 from the query application 34 by way of the application program interface/utility 28 can be determined by the K Engine 14 according to the dataset created by the KStore dataset simulation system 10 and displayed on a graphical display device. Furthermore, queries can be received by the K Engine 14 and responses can be determined from the KStore 12 while a dataset is being created by the simulation system 10 and transmitted to the K Engine 14, and while the KStore 12 is being built and tested using datasets created by the simulation system 10.

Within the KStore dataset simulator system 10 the KStore data simulator 30 collects data record defining parameters from a user or an application or any other source of data by way of a graphics user interface (GUI) 38 for building the KStore 12, wherein the user defines the format of the data according to the modeled process being represented by the data. While building the KStore 12, the KStore data simulator 30 creates data defined by the user to represent at least one modeled process within the KStore 12. The KStore data simulator 30 can create the dataset according to the process and procedure as described in more detail below. The dataset created by the KStore data simulator 30 can then be transmitted from the KStore data simulator 30 directly to the KStore 12 by way of a learn engine 26 and K engine 14. The KStore dataset simulator system 10 is shown with a single learn engine 26 for illustrative purposes. In practice any number of learn engines 26 can be present.

In another preferred embodiment of the invention, the dataset created by the KStore data simulator 30 can be stored in a dataset repository 16. The dataset repository 16 can be a KStore dataset file 20, a KStore dataset message queue 24, a backing store, dynamic storage, such as a named pipe, for buffering and use by the KStore 12 shortly after simulation or any other data base, data structure or medium for storing a dataset, including another KStore 12. In one preferred embodiment of the invention the term repository can be understood to include any location capable of receiving, storing or transmitting a dataset created by the KStore data simulator 30, including the KStore 12 itself.

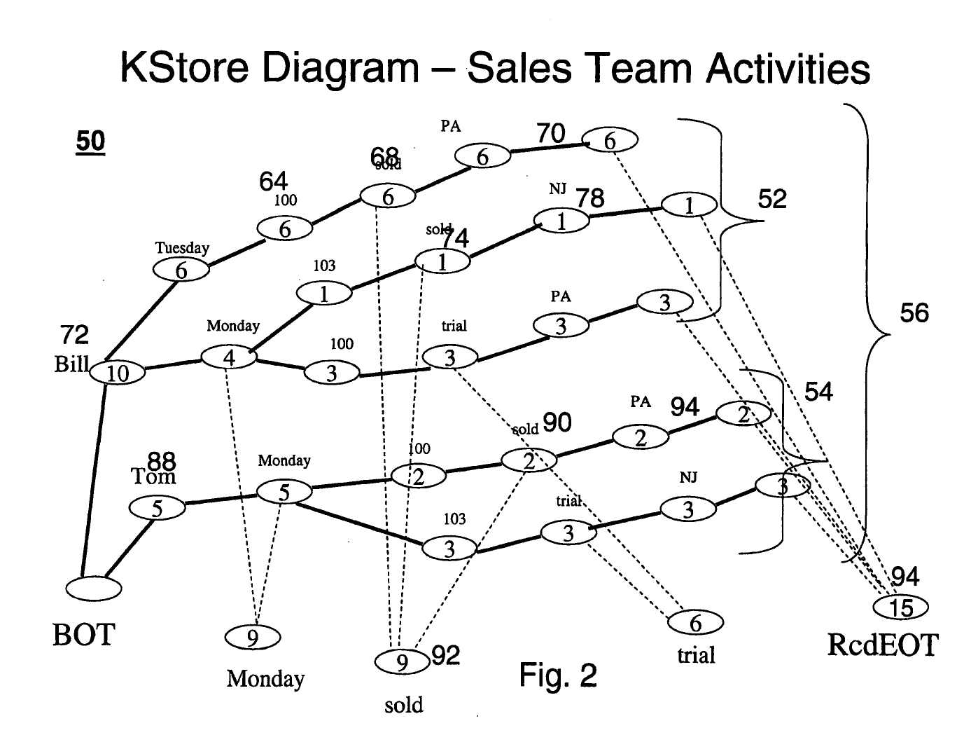

Referring now to FIG. 2, there is shown the interlocking trees datastore 50. The interlocking trees datastore 50 is a diagrammatic representation of a KStore 12 that can be provided within the KStore dataset simulation system 10. The structure and functioning of the interlocking trees datastore 50 is substantially as taught in copending U.S. patent application Ser. Nos. (Numbers to be provided) I assume you want to include TN188, 188A, and 336? Any others? (columns, repositories . . . )<<<>>>

I THINK WE MIGHT AS WELL INCLUDE ANYTHING THAT WE HAVE A SERIAL NUMBER FOR.

Data records such as the data records shown in Table I below can be imported into the interlocking trees datastore 50 or other repository and stored for simultaneous or later access by the user. The methods for building a KStore such as the KStore 12 from data records such as those shown in Table I are also taught in the foregoing patent applications. The methods for creating such data records and for transmitting the data records to the KStore 12 by the KStore data simulator 30 are discussed in more detail below.

TABLE I
Bill Tuesday 100 sold PA
Bill Tuesday 100 sold PA
Bill Tuesday 100 sold PA
Bill Tuesday 100 sold PA
Bill Tuesday 100 sold PA
Bill Tuesday 100 sold PA
Bill Monday 103 sold NJ
Bill Monday 100 trial PA
Bill Monday 100 trial PA
Bill Monday 100 trial PA
Tom Monday 100 sold PA
Tom Monday 100 sold PA
Tom Monday 103 trial NJ
Tom Monday 103 trial NJ
Tom Monday 103 trial NJ

Accordingly, the fifteen data records of Table I set forth the information for a total of fifteen transactions which can be stored as shown in the datastore 50. Thus, all of the data in the datastore 50 may have the same data format and represent a single modeled process. Thus, the datastore 50 thus has a single data source context, the transaction context. Accordingly, the datastore 50 may be referred to as a single data source context datastore. The presence of fifteen data records in the datastore 50 is indicated by the count of the end of thought node 94 which is the sum of the counts of all end product nodes within the datastore 50. It will be understood that the term ‘transactions’ herein includes both the trials and the outright sales shown in the data records of Table I.

The paths representing the fifteen transactions of Table I within the interlocking trees datastore 50 include paths that contain ‘Bill’ 52 and paths that contain ‘Tom’ 54. The ‘Bill’ paths 52 are understood to include all of the paths extending from the Bill subcomponent node 72. The ‘Tom’ paths 54 are understood to include all of the paths extending from the BOT node through the Tom subcomponent node 88. The ‘Bill’ paths 52 and ‘Tom’ paths 54 are collectively referred to as the modeled transaction process paths 56 of the interlocking trees datastore 50. The paths forming the modeled transaction process paths 56 therefore may constitute a representation of a single modeled process, such as sales transactions for a retail furniture store.

In more complex modeled processes, the data of a single modeled process may be in multiple formats and/or a single modeled process may contain multiple modeled processes. The KStore simulation system is capable of generating data sets describing complex modeled (or modelable) processes.

Using the interlocking trees datastore 50 it is possible to determine, for example, that Bill sold six on Tuesday in Pennsylvania by referring to Case path 70 within Bill's paths 52. Furthermore, it is possible to determine that he sold one on Monday in New Jersey by referring to path 78. Additionally, it is possible to determine the total number of items sold by either Bill of Tom by determining the number of times ‘sold’ is used within the interlocking trees datastore 50. This information can be determined by obtaining the count of the sold elemental root node 92. The count of the sold elemental root node 92 is nine.

More importantly, however, it should be noted that seven of the nine instances of ‘sold’ occur in Bill's paths 52, and that the remaining two instances occur in Tom's paths 54. In fact, it is an important feature of the interlocking trees datastore 50 that an elemental root node such as the sold elemental root node 92 can be used in various different paths of a datastore 50 regardless of the logical relationship, or lack of a logical relationship, between the various paths. This feature of the datastore 50 will be discussed in more detail below.

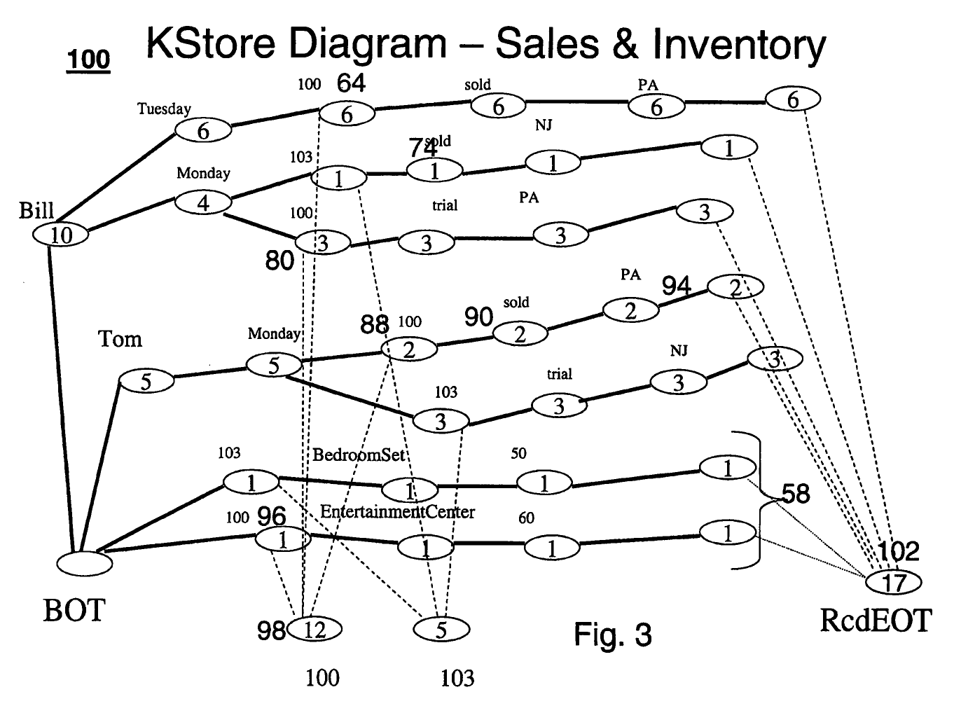

Referring now to FIG. 3, there is shown the interlocking trees datastore 100. The interlocking trees datastore 100 is an alternate embodiment of the interlocking trees datastore 50. Within the interlocking trees datastore 100 Bill's paths 52 extending from the Bill subcomponent node 72 and Tom's paths 54 extending from the Tom subcomponent node 88 are included in the interlocking trees datastore 100, in the same manner previously described with respect to the interlocking trees datastore 50. Bill's paths 52 and Tom's paths form the transaction process paths 56, as also previously described with respect to the datastore 50.

Additionally, the interlocking trees datastore 100 includes the paths 58. The paths 58 form a record of a modeled process that is in addition to the transaction process data represented by the transaction process paths 56. Therefore, the paths 58 are referred to as the inventory process paths 58. The KStore 12 represented as the interlocking trees datastore 100 therefore includes both transaction information, in the modeled transaction process paths 56, and inventory information, within the modeled inventory process paths 58.

Thus, the data stored within the interlocking trees datastore 100 may represent two different modeled processes and have two different data formats. Accordingly, a second data source context, the modeled inventory process context, has been added to the datastore 50 in order to form the datastore 100. Therefore, the datastore 100 may be referred to as a two data source context datastore, a multiple data source context datastore or a complex modeled process datastore containing two modeled sub-processes. The inventory data records represented in the interlocking trees datastore 100 are set forth in Table II below.

TABLE II
103 BedroomSet 50
100 EntertainmentCenter 60

The addition of the two records shown in Table II to the interlocking trees datastore 100 causes the count of the end of thought node to rise from fifteen, for the end of thought node 94 of the interlocking trees datastore 50, to seventeen, for the end of thought node 112. Fifteen of the seventeen records in the interlocking trees datastore 100 are from the modeled transaction process and two are from the modeled inventory process. In one preferred embodiment of the invention the data record of Tables I, II could be provided with a field having two valid variables representing transactions and inventory in order to create the interlocking trees datastore 100.

Within the interlocking trees datastore 100 the 100 elemental root node 98 represents the number ‘100.’ The 100 elemental root node 98 has a count of twelve, indicating that ‘100’ occurs a total of twelve times in the datastore 100. Eleven of the twelve occurrences are in the modeled transaction process paths 56: nine in Bill's paths 52 (see subcomponent nodes 64, 80) and two in Tom's paths 54 (see subcomponent node 88). The one remaining occurrence of the number ‘100’ represented by the 100 elemental root node 98 is in the modeled inventory process paths 58 (see subcomponent node 96). Thus, the number ‘100’ is used in the data from both processes. Furthermore, it is used in different ways in representing the two modeled processes. In the modeled transaction process data the number ‘100’ can indicate a value of a transaction, for example $100.00. In the modeled inventory process it can indicate an item number and thus the identity of the item that is being inventoried. Thus, it will be appreciated that particles or sequences represented by an elemental root node (or root node, depending on the level perspective of the view of K) in the system and method of the present invention can be used in data representing a plurality of different modeled processes to represent entirely different types of variables.

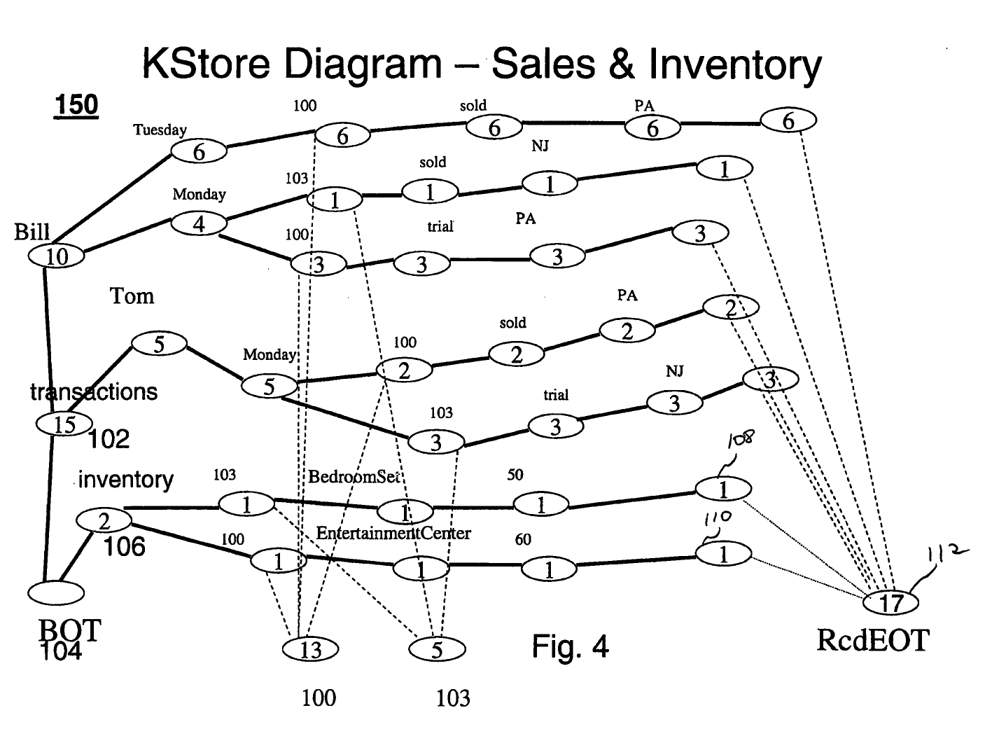

Referring now to FIG. 4, there is shown the interlocking trees datastore 150. The interlocking trees datastore 150 is an alternate embodiment of the interlocking trees datastore 100. Two nodes have been added to the interlocking trees datastore 100 to produce the interlocking trees datastore 150. One of the additional nodes is the transactions sign node 102. The transactions sign node 102 is disposed between the BOT node 104 and the Bill subcomponent node 72. The transactions sign node 102 is also disposed between the BOT node 104 and the Tom subcomponent node 88. Therefore, the transactions sign node 102, from which the modeled transaction process paths 56 depend, can indicate the transaction context within the interlocking trees datastore 150.

The count of the transaction sign node 102 is the total number of transactions in the transaction process, i.e. fifteen. The value of the transaction sign node count can be obtained by summing the counts of the Bill subcomponent node 72 and the Tom subcomponent node 88. Alternately, the value of the transaction sign node can be obtained by summing the counts of all end product nodes within the transaction process paths 56.

The other node added to the interlocking trees datastore 100 to provide the interlocking trees datastore 150 is the inventory sign node 106. The inventory sign node 106 is disposed between the BOT node 104 and the inventory process paths 58. Therefore, the inventory sign node 106 can indicate the inventory context of the interlocking trees datastore 150. It will appreciated that in one embodiment of the invention the sign nodes 102, 106 can be understood to be present in the interlocking trees datastore 100, even though they are not shown in the illustration thereof.

The count of the inventory sign node 106 is the number of data records representing the modeled inventory process. The count of the inventory sign node 106 can be obtained by beginning at the inventory sign node 106 and traversing each path extending therefrom to the respective end product nodes 108, 110. The counts of the end product nodes 108, 110 located in this manner are then summed. Alternately, the count of the inventory sign node 106 can be obtained by determining and summing the counts of all of the end product nodes 108, 110 of the inventory process paths 58. The counts of the end product nodes 108, 110 can be determined according to the asResult list of the RcdEOT node 112 and a context filter for the modeled inventory process paths 58.

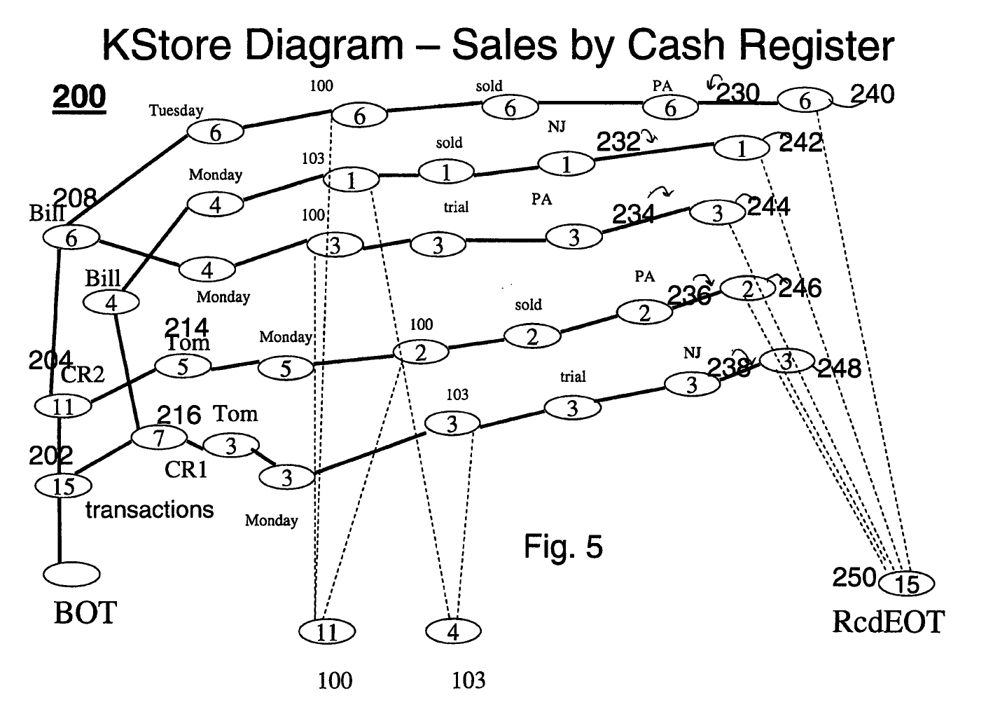

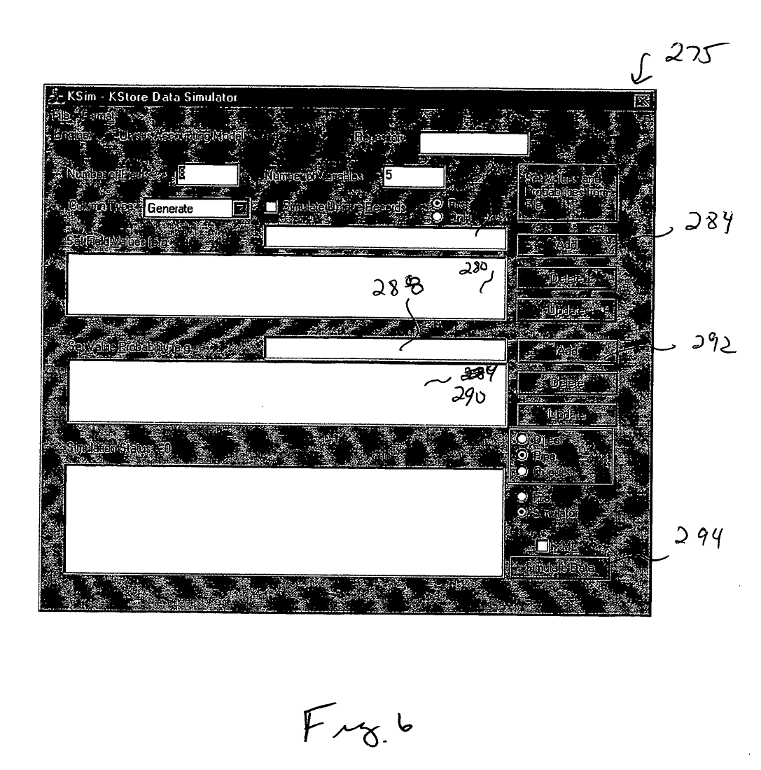

Referring now to FIG. 5, there is shown the interlocking trees datastore 200. The interlocking trees datastore 200 is an alternate embodiment of the interlocking trees datastore 100 wherein the fifteen transactions shown in Table I, i.e. the modeled transactions process paths 56, are organized according to whether they were rung up on a cash register 1 or a cash register 2. The data records represented in the interlocking trees datastore 200 are shown in Table III. It will be understood that Table III contains the same information as Table I, with the addition of a column indicating on which cash register each transaction was rung up.

TABLE III
CR2 Bill Tuesday 100 sold PA
CR2 Bill Tuesday 100 sold PA
CR2 Bill Tuesday 100 sold PA
CR2 Bill Tuesday 100 sold PA
CR2 Bill Tuesday 100 sold PA
CR2 Bill Tuesday 100 sold PA
CR1 Bill Monday 103 sold NJ
CR2 Bill Monday 100 trial PA
CR2 Bill Monday 100 trial PA
CR2 Bill Monday 100 trial PA
CR2 Tom Monday 100 sold PA
CR2 Tom Monday 100 sold PA
CR1 Tom Monday 103 trial NJ
CR1 Tom Monday 103 trial NJ
CR1 Tom Monday 103 trial NJ

Fifteen data records are represented within the interlocking trees datastore 200 as indicated by the count of the transaction sign node 202. This is also indicated by the count of the end of thought node 250 of the interlocking trees datastore 200. Traversing the interlocking trees datastore 200 from the transactions sign node 202 it can be determined, for example, that eleven of the fifteen transactions in the datastore 200 were rung up on cash register 2. In order to make this determination the interlocking trees datastore 200 can be traversed from the CR2 sign node 204 to all of the end product nodes depending therefrom (i.e. the end product nodes 240, 244, 246). The counts of each of the end product nodes 240, 244, 246 that are located in this manner can then be added together to determine the count of the CR2 sign node 204.

Thus, the foregoing traversals could first determine all of Bill's transactions that were rung up on cash register 2 by traversing from the CR2 sign node 204 to the Bill subcomponent node 208. The traversal of the datastore 200 could continue along the paths 230, 234 to the end product nodes 240, 244. The end product nodes 240, 244 have counts of six and three, respectively. Next the traversal of the interlocking trees datastore 200 could determine how many of Tom's transactions were rung up on cash register 2 by traversing from CR2 sign node 204 to the Tom subcomponent node 214. Traversal could continue along the path 236 to the end product nodes 246, which has a count of two.

Therefore, the total number of transactions rung up on cash register 2 is eleven. In the same manner the number of transactions rung up on cash register 1 can be determined by traversing the interlocking trees datastore 200 from the CR1 sign node 216. The traversal would proceed from the CR1 sign node 216 through the path 232 (for Bill's transactions) and through the path 238 (for Tom's transactions) to the end product nodes 242, 248 and summing the counts of the end product nodes 242, 248.

The configuration file shown in Table IV, the configuration file 1, can be provided as an input to the KStore data simulator 30 to create the data records of Table I and thus the interlocking trees datastore 50. The configuration file 1 can be transmitted to the KStore data simulator 30, for example, by way of the GUI 38. Within the configuration file 1 the first row defines the number of fields in the data records of Table I. In this manner the five fields of the data records simulated according to the configuration file 1 as shown in Table I can be defined. The names of the five defined fields are shown in the configuration file 1 below the definition of the number of fields. They are SalesPerson, DayOfWeek, Item#, Transaction and State.

Next the possible values or variables within each of the fields can be set forth. For example, SalesPerson can have the value Bill or the value Tom. DayOfWeek can have the value Monday or the value Tuesday, etc. If no specific values are specified for a field of variables default values are created. For example, if a field is defined to have i values with no specified value names the KStore data simulator 30 can create the values v₁, v₂ . . . vᵢ. In this manner the configuration file 1 of Table IV can be used to build the data representing the modeled transaction process as shown in the interlocking trees datastore 50.

TABLE IV
[Configuration 1]
Fields = 5
Variables = 10
[Column Names]
1 = SalesPerson
2 = DayOfWeek
3 = Item#
4 = Transaction
5 = State
[Value]
SalesPerson: Bill, Tom
DayOfWeek: Monday, Tuesday
Item#: 100, 103
Transaction: sold, trial
State: PA, NJ
[Probability]
SalesPerson: Bill = 66 2/3%
SalesPerson: Tom = 33 1/3%
DayOfWeek: Monday = 66 2/3%
DayOfWeek: Tuesday = 33 1/3%
Item#: 100 = 66 2/3%
Item#: 103 = 33 1/3%
Transaction: sold = 66 2/3%
Transaction: trial = 33 1/3%
State: PA = 66 2/3%
State: NJ = 33 1/3%

The next set of definitions within the configuration file 1 is the probabilities. Using the probability definitions of the configuration file 1 the user can assign a probability to each value defined therein. For example the user can instruct the KStore data simulator 30 to select Bill 66⅔% of the time and to select Tom 33⅓% of the time. In the preferred embodiment of the invention the user is not required to define any probabilities in this manner unless such probabilities are desired. If the user chooses not to define any probabilities the KStore data simulator 30 can automatically implement a default condition in which all values in a field are selected with an equal probability.

Alternately, a user can define probabilities for some values and permit the KStore data simulator 30 to distribute the remaining probabilities equally over the values not having a user-defined probability. The probabilities that are not defined can default to equal probabilities. It should be understood that the user can list any number of values for a field and limit use of the values by the KStore data simulator 30 to a selected subset of the values by assigning probabilities of zero to the unselected values.

If the probabilities selected in the configuration file 1 are compared with the frequencies at which the corresponding values appear in Table IV it will be noted that the frequencies are not always exactly as defined in the configuration file 1. This is due to the fact that the frequencies must approach the assigned probabilities as the number of data records created by the KStore data simulator 30 gets relatively large. In fact, the examples of Tables I, IV have been simplified for illustrative purposes. In practice the probabilities assigned in a configuration file and the frequencies at which the values appear in the output data records of the configuration file 1 can be expected to converge more slowly than they do in the examples shown. Furthermore, until a very large number of data records are created by the KStore data simulator 30 the observed probabilities can be expected to fluctuate.

In one preferred embodiment of the invention the record and field counts can be displayed, for example on the graphical user interface 38, during simulation by the KStore dataset simulation system 10 to permit the user to monitor the relative frequencies of occurrence for any of the values defined. Additionally the cumulative frequencies of the values defined and any other information required by the user can be displayed on the graphical user interface 38. The displayed counts and probabilities may be updated by the KStore dataset simulation system 10 at intervals which are selectable by the user. For example, the user can select updates every second, every five seconds, etc.

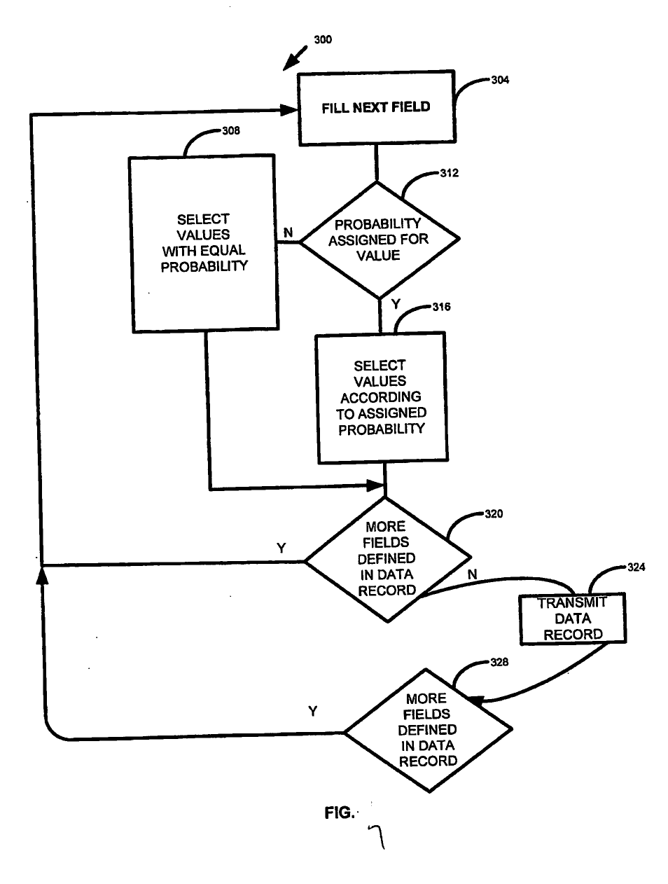

Referring now to FIG. 6, there is shown a screen shot 275 representative of a graphic user interface 38 within the KStore dataset simulator system 10. Different screen shots such as the screen shot 275 can be used for inputting data records such as the data records shown in Tables I, II and III into the KStore data simulator 30 to create data representing one or more modeled processes for storage or use by a KStore. The screen shot 275 includes a field entry space 278 for entering field values and an add button 284 for adding the entered field values to a list of values displayed in the field value display 280. A probability entry space 288 is provided for entering probabilities to be added to a list of probabilities displayed in the probability display space 290 by depressing the add button 292.

Thus, a set of parameters defining data that represents a modeled process can be entered by way of the graphic user interface 38 using the format illustrated by the screen shot 275. Accordingly, the KStore data simulator 30 can be instructed to begin simulation of the user defined data by depressing the simulate data button 294. It will be understood that the screen shots set forth herein such as the screen shot 275 are provided for illustrative purposes only. Any suitable type of graphical user interface and any type of display representing a graphical user interface known to those skilled in the art can be used for interfacing with the KStore dataset simulator system 10 according to the invention.

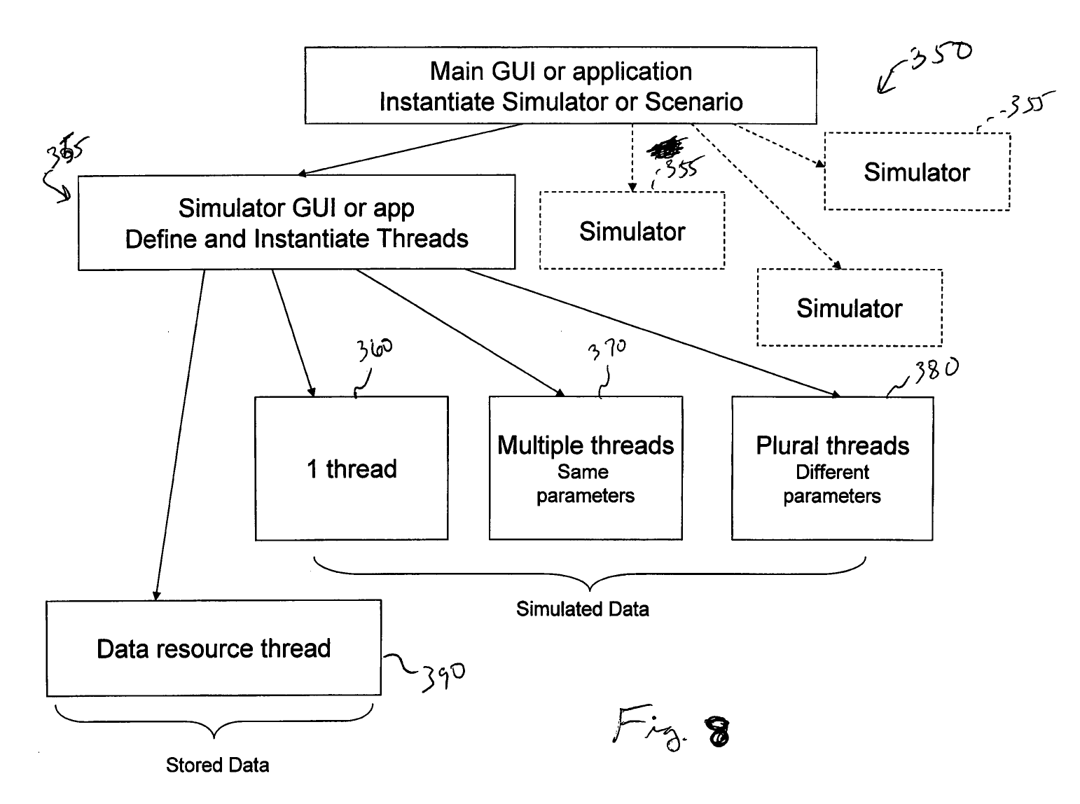

Referring now to FIG. 7, there is shown the data record creation process or procedure 300. Using the data record creation procedure 300 in cooperation with the configuration file 1 the KStore data simulator 30 can create a stream of data records such as the data records in Table I. When execution of the KStore data simulator 30 is begun it creates a field of a data record as shown in block 304. In the current examples, data record creation process 300 can first select one of two values for the SalesPerson field within the configuration file 1, Bill or Tom.

According to a configuration file such as the configuration file 1 a determination is made in decision 312 of the data record creation procedure 300 whether probabilities have been assigned for the values available for the SalesPerson field. Using the probabilities that have been assigned in the configuration file 1 Bill is selected twice as often as Tom is selected, as shown in block 316. If no probabilities have been assigned the values Bill and Tom would be selected with equal frequency. In the first data record of Table I block 316 of the data record creation process 300 operating within the KStore data simulator 30 selected the value Bill.

The data record creation process or procedure 300 then makes a determination whether any more fields are defined within the current data record as shown in decision 320. Since more fields are defined within the data record being created execution of the data record creation process 300 can return to block 304 where the value Monday or the value Tuesday can be selected for the next field, the DayOfWeek field. These operations are repeated until a value is selected for each field in the data record as defined in the configuration file 1 and a negative determination is obtained in decision 320. The foregoing data record creation process can be repeated to create as many data records as desired. When enough data records are created in this manner a negative determination is obtained within decision 320.

In one preferred embodiment of the data record creation procedure 300 each completed data record can then be transmitted individually to the KStore 12 or to the dataset repository 16 as shown in block 324. In another preferred embodiment of the invention a plurality of data records can be accumulated by the data record creation process 300. The accumulated data records can then be transmitted as a group to the KStore 12 or a dataset repository 16.

Furthermore, as known to those skilled in the art, during the time that the data records are transmitted to the KStore 12, the KStore 12 is built using a process that creates new pointers to represent each new node on a node by node basis. Until the building of a new node is complete it cannot be available for queries of the KStore 12. Thus, nodes under construction are, by definition locked out for queries of the KStore 12. However, since such a single node under construction is the only point in the KStore 12 that is under construction at any point in time, the KStore 12 does not require any of its remaining nodes to be locked out while it is being built.

[IS THE LAST SENTENCE TRUE? DON'T OTHER NODES HAVE TO BE LOCKED OUT WHEN THEIR ASCASE OR ASRESULT LISTS ARE UPDATED TO INCLUDE THE NEW NODE?]

Therefore, it is an important advantage of the system and method of the present invention that the KStore 12 can be queried simultaneously with the transmission of data records from the data record creation procedure 300 to the KStore 12 and the building of the KStore 12 according to the data records it receives. This is true regardless of how many threads are being executed by a data simulator 30, how many data simulators 30 are instantiated and how many different modeled processes are being represented within the KStore 12 (as described in more detail below), since under all of these different circumstances only the nodes under construction are unavailable.

Referring now to FIG. 8, there is shown a block diagram representation 350 setting forth some possible configurations of the KStore data simulator 30. The different configurations of the KStore data simulator 30 correspond to different modes of executing one or more instances 355 of the data record creation process 300. The different modes of execution of the instances 355 can operate simultaneously and can create one or more data streams for transmission to a KStore 12 or dataset repository 16 according to the method of the present invention. The streams of data records created according to possible configurations shown the block diagram representation 350 can have one or more formats and can build data representing one or more modeled processes within the KStore 12. Furthermore, any number of individual streams of data records of a plurality of streams of data records being created simultaneously can be stopped and started independently of the remaining streams.

A single instance 355 of the record creation process or procedure 300 can be executed to create a single stream of data records using a single thread for transmission to a KStore 12 or repository 16 to test or demonstrate a KStore 12 as shown in block 360 of the block diagram representation 350. Furthermore, any number of single thread instances as shown in block 360 can be instantiated at the same time. In addition to such single thread operation, it will be understood by those skilled in the art that multiple thread execution of the record creation process 300 can be performed by an instance 355. During multiple thread execution two or more streams of data records can be created and transmitted simultaneously in real time as shown in blocks 370, 380. Each thread that runs within the KStore data simulator 30 may instantiate its own learn engine 26 within the KStore dataset simulation system 10.

Furthermore, the multiple thread operation of an instance 355 according to the present invention can be implemented using the multithread computing environment well understood by those skilled in the art. In such a multithread computing environment each thread of the instance 355 can be assigned its own stack of activation frames, in which the activation frames are created and destroyed according to, for example, calls to and returns from various objects within the computing environment. In this manner any number of threads of a multiple thread instance 355 can be simulated simultaneously in real time. Furthermore, since the different threads of a multithread instance 355 can provide data representing different modeled processes and having different data formats, streams of data having any number of different data formats can be provided simultaneously in real time by a single instance 355 within the KStore dataset simulator system 10.

The data streams created according to blocks 360, 370 and 380 can form multiple data sets or can be merged into a single dataset. The multiple threads executed according to blocks 370, 380 can use the same configuration files or different configuration files. In one embodiment of the invention multi thread operation of the record creation process 300 on a single instantiation 355 can be achieved by interleaving the creation of the threads. In the interleaved thread embodiment the record creation process 300 can create a predetermined number of data records for one thread and then create a predetermined number of data records for another thread. This process can be repeated in a continuous alternating manner to provide the multiple threads.

In another preferred embodiment a simulation can be mapped to real time. In the time mapping embodiment timers which are well known to those skilled in the art can be used to map, for example, one second of real time into one day or one month of simulated modeled process operation. In the example where a second of real time is mapped to a day a user could create a simulation of, for example, a one week sale occurring during an ongoing simulation of a modeled transaction process. While the transactions are being simulated at the rate of one second per day the timer could be used to start a thread corresponding to the modeled sale process at one point in time and stop it seven seconds later. This permits the user to test any modeled process or changes of modeled process parameters over any predetermined period of time. Other gating or unfolding/recurring parameters like real time can be modeled in a similar way.

Thus, in one preferred embodiment, when the record creation procedure 300 is instantiated one or more times simultaneously, all instances 355 of the record creation process 300 can be executed as single thread instantiations 355 as shown in block 360. In this embodiment each single thread instance 355 can create its own stream or streams of data records. Additionally, each single thread instantiation 355 of a plurality of single thread instantiations can use the same or differing configuration files for input. Furthermore, multiple single instantiations 355 can create streams of data records having the same or different formats. The data streams created by plural single thread instantiations 355 according to block 360 can be transmitted from the instances 355 simultaneously in real time. They can form multiple data sets or can be merged into a single dataset.

In one preferred embodiment multiple threads within a single instance 355 can execute one or more configuration files having the same set of modeled process defining parameters as shown in block 370. The multiple threads operating in this manner can build a KStore 12 or multiple KStores 12 representing a single modeled process such as the single process represented by the data records in Table I and the interlocking trees datastore 50. Multiple instances 355 according to block 370 can use either the same configuration files or different configuration files provided the configuration files have the same modeled process defining parameters. Furthermore, any number of threads can execute with the same parameters on a single instance 355 of the record creation process 300 according to block 370.

Additionally, multiple threads within an instance 355 can execute upon configuration files having different process defining parameters as shown in block 380. For example, multiple threads operating upon a single instance 355 with different process defining parameters can create data records such as the ones shown in Tables I, II and create the modeled transaction process paths 56 and the modeled inventory process paths 58 of the interlocking trees datastore 100. The output data streams of instances 355 according to block 380 can be transmitted simultaneously in real time. Additionally, a data resource thread 390 can read data from a backing store, a message queue, a pipe or any other source of data including another KStore 12 as previously described with respect to the dataset repository 16 of FIG. 1. Furthermore, non-simulator generated message queues, monitoring devices and even sensors (heat, light, haptic, chemical, et cetera) can be used for such input.

Thus, it is sometimes necessary to use a plurality of configuration files within the KStore data simulator 30 simultaneously in order to obtain a plurality of data streams for transmission to KStores 12 or repositories 16 according to the instantiations shown in the block diagram representation 350. One way to accomplish this is to use a scenarios configuration such as the scenarios configuration shown in Table V. A scenario includes a list of configurations, such as the configuration shown in Table IV, for providing individual sets of modeled process defining parameters and data to either single or multiple instances 355 of the record creation process 300.

The scenarios configuration shown in Table V includes three configurations: Furniture Demo 1, Furniture Demo 2 and Furniture Demo 3. Each configuration shown in Table V specifies the number of threads to be run on the instance 355 it specifies. Although all of the configurations in the example of Table V specify a single thread, any number of threads can be specified in the configurations within a scenario as previously described. Additionally, the scenarios configuration of Table V includes three additional scenarios, each being defined to include one or more configurations in the same manner, Furniture Sales Data Scenarios 1, 2 and 3. Thus, in the method of the present invention a scenario can include further scenarios specifying any different number of threads

TABLE V
Scenarios Configuration
[Furniture Demo 1]
KSimm.exe -SETTINGS “furn1.Txt” -THREADS 1
[Furniture Demo 2]
KSimm.exe -SETTINGS “furn2.Txt” -THREADS 1
[Furniture Demo 3]
KSimm.exe -SETTINGS “furn3.Txt” -THREADS 1
[Furniture Sales Data Scenario 1]
KSimm.exe -SETTINGS “Furniture Sales Data.Txt” -THREADS 1
[Furniture Sales Data Scenario 2]
KSimm.exe -SETTINGS “Furniture Sales Data 2.Txt” -THREADS 1
[Furniture Sales Data Scenario 3]
KSimm.exe -SETTINGS “Furniture Sale data 3.Txt” -THREADS 1

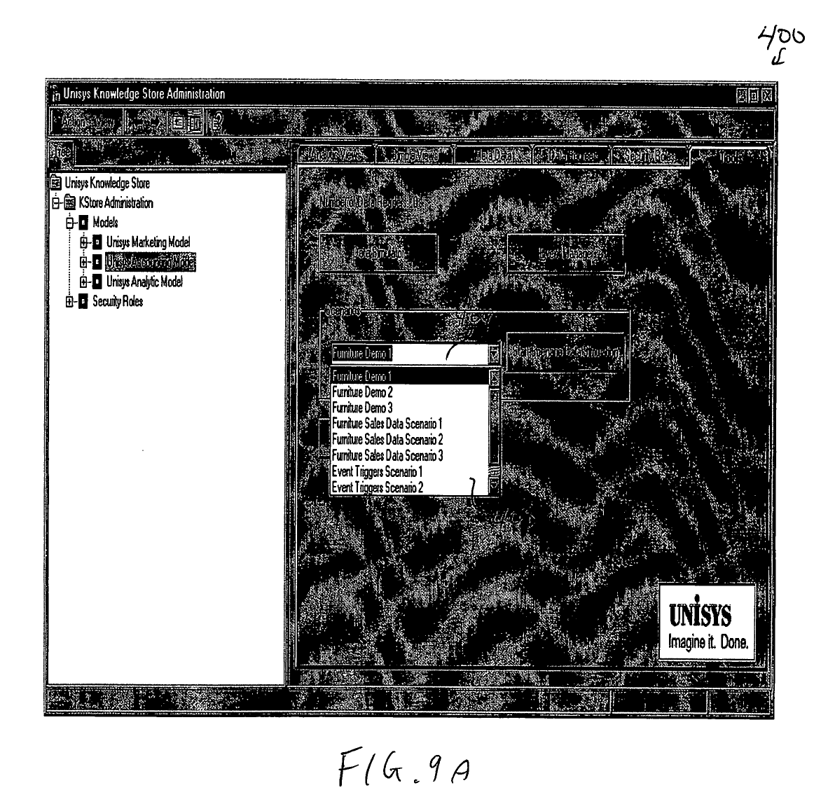

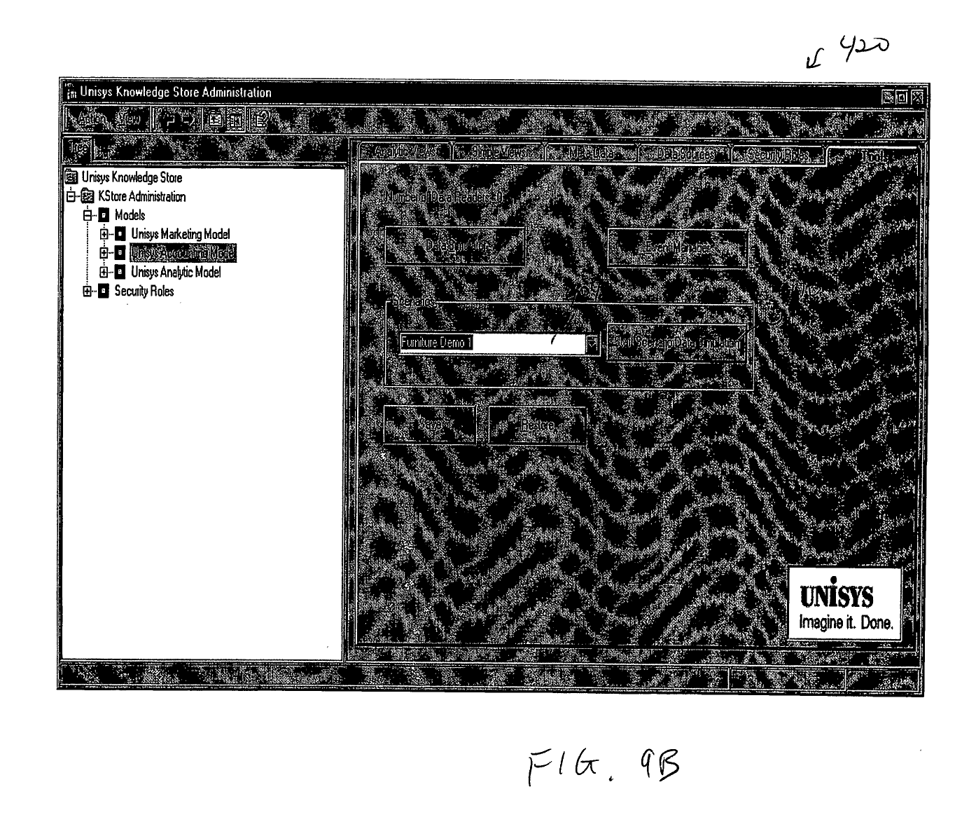

Referring now to FIGS. 9A, B, there are shown the screen shots 400, 420 of the graphic user interface 38 within the KStore dataset simulator system 10 which can be used to specify scenarios such as the scenario set forth in Table V to the KStore data simulator 30. As shown in the screen shot 400 the graphic user interface 38 can be provided with a drop down scenario menu 408 listing any number of scenarios defined by the user of the dataset simulator system 10. The user selects a scenario by scrolling the drop down scenario menu 408 to move a selected scenario into the scenario display field 404 of the screen shot 400. When the selected scenario is displayed in the scenario display field 404 in this manner the user of the KStore data simulator 30 can depress the start scenario button 410 to begin simulation and the creation of data records according to the configurations specified by the selected scenario.

While the invention has been described in detail and with reference to specific examples thereof, it will be apparent to one skilled in the art that various changes and modifications can be made therein without departing from the spirit and scope thereof

Furthermore, the methods and system described herein may be embodied in the form of program code (e.g. instructions). The program code can be stored on any computer readable medium. For example the program code can be stored on media such as a floppy diskette, CD-ROM, DVD-ROM, DVD-RAM, hard disk drive, memory stick, main memory, or any other machine-readable storage medium known or currently unknown wherein, when the program code, which itself is a set of organized data signals in electronic, optical or other form, is loaded into and executed by a machine, such as a computer, the machine can become an apparatus for practicing the invention. The present invention may also be embodied in the form of program code that is transmitted over a transmission medium. For example the program code can be transmitted over electrical wiring or cabling, through fiber optic transmission devices, over a network, including the Internet or an intranet, or via any other form of transmission wherein the machine becomes an apparatus for practicing the invention when the program code is received and loaded into and executed by a machine, such as a computer. When implemented on a general purpose processor, the program code combines with the processor to provide an apparatus that operates analogously to specific logic circuits. The program code may be implemented using a high level programming language, such as, for example, C, C++, or Java. Alternatively, the program code may be implemented in assembly or machine language. In any case, the language may be compiled or an interpreted language.

It is noted that the foregoing description has been provided merely for the purpose of explanation and are in no way to be construed as limiting of the present invention. For example, the interlocking trees datastore can be implemented using object-oriented technologies, procedural technologies, a hybrid thereof or any other suitable methodology. Furthermore, although the examples presented show the dataset elements stored in a memory, one of skill in the art will understand that this functionality can be implemented in many different ways. For example, the invention contemplates the use of many different sets of dataset elements of many different universes stored on multiple remotely located machines.

While innumerable uses for this invention may be found, and significant variability in the form and manner of operation of this invention are described and will occur to those of skill in these arts, the invention is not limited in scope further than as set forth in the following claims.

What is claimed is:

1. A method for generating data for a KStore, comprising:
collecting modeled process defining parameters to provide at least one defined modeled process;
instantiating a first simulator;
creating a data stream by said at least one simulator in accordance with said defined modeled process; and
transmitting said at least one data stream to a repository.

2. The method for generating data for a KStore of claim 1, further comprising executing a single thread by said first simulator.

3. The method for generating data for a KStore of claim 2, further comprising executing a plurality of threads by said first simulator.

4. The method for generating data for a KStore of claim 3, further comprising:
collecting a single set of modeled process defining parameters; and
providing a single modeled process in accordance with said single set of modeled process defining parameters.

5. The method for generating data for a KStore of claim 4, further comprising instantiating a second simulator.

6. The method for generating data for a KStore of claim 5, further comprising executing a single thread on said second simulator.

7. The method for generating data for a KStore of claim 5, further comprising:
executing a plurality of threads on said second simulator;
collecting a plurality of sets of modeled process defining parameters; and
providing a plurality of modeled processes in accordance with said plurality of sets of modeled process defining parameters.

8. The method for generating data for a KStore of claim 3, further comprising transmitting a plurality of data streams according to said plurality of threads.

9. The method for generating data for a KStore of claim 8, further comprising transmitting said plurality of data streams to a single KStore.

10. The method for generating data for a KStore of claim 8, wherein the data streams of said plurality of data streams are transmitted in real time.

11. The method for generating data for a KStore of claim 10, wherein the data streams of said plurality of data streams are transmitted simultaneously.

12. The method for generating data for a KStore of claim 3, further comprising:
collecting a plurality of sets of modeled process defining parameters; and
providing a plurality of modeled processes in accordance with said plurality of sets of modeled process defining parameters.

13. The method for generating data for a KStore of claim 12, further comprising transmitting a plurality of data streams according to said plurality of threads.

14. The method for generating data for a KStore of claim 13, further comprising transmitting said plurality of data streams to a single KStore.

15. The method for generating data for a KStore of claim 13, wherein the data streams of said plurality of data streams are transmitted in real time.

16. The method for generating data for a KStore of claim 15, wherein the data streams of said plurality of data streams are transmitted simultaneously.

17. The method for generating data for a KStore of claim 13, further comprising transmitting said plurality of data streams to a plurality of KStores.

18. The method for generating data for a KStore of claim 13, further comprising transmitting said plurality of data streams to a temporary data storage device.

19. The method for generating data for a KStore of claim 1, further comprising transmitting a plurality of data streams according to said first simulator.

20. The method for generating data for a KStore of claim 19, further comprising:
collecting a plurality of sets of modeled process defining parameters; and
providing a plurality of modeled processes in accordance with said plurality of sets of modeled process defining parameters.

21. The method for generating data for a KStore of claim 19, further comprising transmitting said plurality of data streams to a single KStore.

22. The method for generating data for a KStore of claim 19, wherein the data streams of said plurality of data streams are transmitted in real time.

23. The method for generating data for a KStore of claim 22, wherein the data streams of said plurality of data streams are transmitted simultaneously.

24. The method for generating data for a KStore of claim 1, further comprising instantiating a plurality of simulators.

25. The method for generating data for a KStore of claim 24, further comprising executing a single thread on at least one simulator of said plurality of simulators to provide a single data stream.

26. The method for generating data for a KStore of claim 25, further comprising executing a plurality of threads on said at least one simulator of said plurality of simulators to provide a corresponding plurality of data streams.

27. The method for generating data for a KStore of claim 26, further comprising providing a plurality of modeled processes corresponding to said plurality of data streams.

28. The method for generating data for a KStore of claim 26, further comprising transmitting said plurality of data streams simultaneously in real time.

29. The method for generating data for a KStore of claim 28, wherein said plurality of data streams comprises at least two data streams having differing data stream formats.

30. The method for generating data for a KStore of claim 26, further comprising instantiating a learn engine for each thread of said plurality of threads.

31. The method for generating data for a KStore of claim 1, further comprising:
providing a configuration file having configuration information for configuring data; and
arranging data record values in data record fields of a data record in accordance with said configuration information to provide a configured data record.

32. The method for generating data for a KStore of claim 31, further comprising inserting said configured data record into said at least one data stream.

33. The method for generating data for a KStore of claim 32, wherein said configuration file comprises a plurality of variable names.

34. The method for generating data for a KStore of claim 33, wherein said configuration file includes a plurality of variable values further comprising assigning said variable values to said variable names.

35. The method for generating data for a KStore of claim 34, wherein said configuration file includes a probability value further comprising selectively assigning said variable values to said variable names in accordance with said probability value.

36. The method for generating data for a KStore of claim 34, wherein said configuration file comprises a plurality of different user-provided probability values further comprising selectively assigning said variable values to said variable names in accordance with plurality of different user-provided probability values.

37. The method for generating data for a KStore of claim 34, further comprising selectively assigning said variable values to said variable names in accordance with a predetermined probability value.

38. The method for generating data for a KStore of claim 31, further comprising:
providing a scenario file having a plurality of configuration files; and
arranging data record values in data record fields in accordance with said plurality of configuration files to provide a plurality of configured data records.

39. The method for generating data for a KStore of claim 38, further comprising providing a plurality of modeled processes in accordance with said plurality of configuration files.

40. The method for generating data for a KStore of claim 38, wherein said scenario file includes at least one further scenario file further comprising arranging said data record values in data record fields in accordance with said at least one further scenario file to provide said plurality of configured data records.

41. The method for generating data for a KStore of claim 1, further comprising:
building said KStore; and
determining a context within said KStore simultaneously with said building of said KStore.

42. The method for generating data for a KStore of claim 41, further comprising building said KStore in accordance with said at least one data stream.

43. The method for generating data for a KStore of claim 1, wherein if one of the modeled process defining parameters is time, mapping clumps of simulator data around a selected period of time, such that for any given number of units of said selected time periods, a same number of clumps of simulated data will be produced.

44. A computer system configured to execute program instructions which when executing execute a method as set forth in claim 1.

45. A data file in a computer readable memory, containing program instructions which when executing in a computer system execute a method as set forth in claim 1.
